(19) United States
(12) Patent Application Publication
(10) Pub. No.: US 2022/0054870 A1
(43) Pub. Date: Feb. 24, 2022

(54) Face Mask Communication System

(71) Applicant: Joseph LaCombe, Colorado Springs, CO (US)

(72) Inventor: Joseph LaCombe, Colorado Springs, CO (US)

(21) Appl. No.: 17/367,777

(22) Filed: Jul. 6, 2021

Related U.S. Application Data
(60) Provisional application No. 63/069,097, filed on Aug. 23, 2020.

(51) Int. Cl. A62B 18/08; G09B 21/00; H04R 1/02; H04R 1/08; H04R 3/04; G10L 15/26; G10L 21/10

(52) U.S. Cl. CPC A62B 18/08; G09B 21/009; H04R 1/028; H04R 1/083; H04R 1/023; F21V 33/0008; G10L 15/26; G10L 21/10; H04R 2420/07; H04R 2430/01; H04R 3/04

(57) ABSTRACT

This present invention relates to a face mask communication system having a face mask equipped with a built-in speaker, amplifier and microphone to enable a wearer to more clearly communicate with others without having to remove his or her face mask. More specifically, the wearer can speak into the microphone, which is amplified through the speaker to project the voice of the wearer to other people in the vicinity of the mask wearer.

### CROSS-REFERENCE TO RELATED APPLICATION

The present application claims priority to, and the benefit of, U.S. Provisional Application No. 63/069,097, which was filed on Aug. 23, 2020 and is incorporated herein by reference in its entirety.

### FIELD OF THE INVENTION

The present invention relates generally to the field of personal protective equipment. More specifically, the present invention relates to an improved face mask featuring a communication system that includes a microphone and an internal speaker to ensure the mask wearer is easily heard by others while speaking and wearing the mask. The speaker amplifies the voice received from the microphone, in situations where it is otherwise difficult to project the sound of the individual through the mask. Additionally, the face mask includes both a small battery and a charging port that work in conjunction to power the speaker and microphone system. The uniquely designed face mask enables teachers, presenters, regular users, doctors, surgical professionals, nurses and others to project their voice while maintaining the safety of both themselves and others by wearing a protective face mask. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various types of germs, viruses, diseases, bacteria, particulate material and other harmful pathogens are present in everyday surroundings. Unfortunately, these harmful materials can be easily inhaled by individuals, and can be extremely dangerous for their health and well-being. Therefore, there is always a need for individuals to protect themselves from the transmission of harmful pathogens, infectious diseases, particulate matter, etc., which may make breathing difficult.

Various solutions have been proposed in the state of the art for the containment and mitigation of pandemics and the spread of infectious diseases. For example, individuals are cautioned to maintain personal hygiene, wash their hands frequently, wear protective face masks, maintain social distancing and more. Further, in some locations, wearing a protective face mask has become a mandatory measure, and at least recommended in other locations, to prevent the spread of infectious diseases, especially during a pandemic. Most face masks are designed to cover the nose and the mouth of the wearer, and form a barrier between the nasal/oral passage and the environment to prevent the transmission of germs, bacteria, viruses, pathogens, diseases and other harmful pathogens.

Although protective face masks help in the prevention of the spread or transmission of diseases and other harmful pathogens, they also present other challenges. For example, an individual wearing a face mask may have difficulty clearly communicating with others because the words are muffled by the face mask. This may result in the individual not being properly heard or being misinterpreted by those with whom the individual is communicating. Additionally, individuals such as teachers, trainers, lecturers, doctors, surgical professionals, nurses, presenters and the like may also have difficulty in projecting their voice sufficiently to other people or to an audience, particularly in large open spaces such as classrooms or auditoriums.

To overcome these difficulties, the individual attempting to speak from behind the face mask may have to shout or speak loudly in order to be heard by others. However, it is not feasible to continuously speak loudly while talking or instructing others. Also, an individual may quickly become exhausted if having to speak in such volumes or tones for a prolonged period of time. Further, removing the face mask to communicate more clearly and effectively is oftentimes not feasible because of mandates that require the individual to wear a mask in such settings. Additionally, removing the face mask, even if allowed, could expose both the wearer and others in close proximity to the wearer to potential transmission of harmful pathogens, infectious diseases, particulate matter and the like.

Therefore, there exists a long felt need in the art for a protective face mask that protects an individual and those in close proximity to the individual against the transmission of harmful pathogens and the spread of infectious diseases, and that enables the wearer to effectively communicate with others while wearing the face mask. There is also a long felt need in the art for a protective face mask that allows the wearer to remain masked while instructing or communicating with others so that the audience hears the information being conveyed by the wearer, and that eliminates the need for the wearer to shout or otherwise speak loudly to be heard. Further, there is a long felt need in the art for a protective face mask that enables the wearer to project his or her voice without straining and while maintaining appropriate social distancing. Finally, there is a long felt need in the art for a protective face mask that is relatively inexpensive to manufacture and that is both safe and easy to use.

The subject matter disclosed and claimed herein, in one embodiment thereof, comprises a novel protective face mask comprised of an integrated microphone and speaker to enable effective, clear and audible communication from the wearer, while also maintaining the safety of the wearer and those individuals in close proximity thereto. The microphone picks up the sounds of the wearer's words, and the speaker amplifies the same to increase the coverage and broadcasting of the sounds in a clear and effective manner.

In this manner, the novel face mask communication system of the present invention accomplishes all of the forgoing objectives, and provides a relatively safe, convenient and efficient solution to enabling an individual to communicate clearly with others while wearing a face mask. The face mask communication system of the present invention is also user friendly, as it does not require the individual wearer to remove the face mask, shout or even speak loudly in order to be heard by others, thereby reducing the threat of potential transmission of harmful pathogens, infectious diseases, particulate matter and the like.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a novel face mask communication system comprised of a protective face mask and an integrated microphone and speaker to enable effective and audible communication, while also reducing the potential spread of harmful pathogens, infectious diseases, particulate matter and the like. The microphone is integrated into the novel face mask and is used to pick up sound signals from the wearer of the face mask. In turn, the microphone is in electrical communication with the speaker such that the speaker amplifies and emanates the sound signals picked up by the microphone to increase the coverage thereof and to project such sound signals a greater distance in a clear and effective manner.

In a further embodiment of the present invention, a novel microphone face mask combination is disclosed that amplifies the voice signals of a wearer of the face mask. The face mask is useful for projecting the voice of the wearer over greater distances, but filters out non-verbal sounds like those associated with breathing. More specifically, the microphone ignores sounds having less than 20 dB so as to filter out the wearer's breathing and/or whisper sounds. A speaker with an integrated amplifier is also provided along the surface of the face mask to both receive and amplify the captured voice signals from the microphone.

In yet a further embodiment of the present invention, a novel protective face mask system that is configured to protect the wearer thereof from airborne pathogens and other contaminants, and that utilizes a wireless microphone to transmit the voice signals of the wearer is disclosed. More specifically, the novel system utilizes a wireless communication module to provide a wireless channel to an electronic device, and a built-in microphone to pick up voice signals of the wearer and wirelessly transmit the voice signals to the electronic device.

In yet a further embodiment of the present invention, a method of amplifying voice signals of an individual while wearing a face mask to increase the range and power of the voice signals is disclosed. The method comprises the steps of turning on a built-in speaker and a built-in microphone in the face mask through a toggle button present on the outer surface of the face mask. Next, utilizing the built in microphone to capture the individual's voice signals, and then amplifying the captured voice signals through the integrated speaker. The amplified voice signals are then emitted through the speaker so that the amplified voice signals are able travel a greater distance than if the individual were speaking without the amplification system and/or without wearing the protective mask.

As noted above, in any of the aforementioned potential embodiments, the microphone may be comprised of a high pass filter to filter out sound signals of lower frequencies including, without limitation, the sounds of the mask wearer breathing and other generally inaudible sounds. The microphone and the speaker can also be activated automatically through the presence of sound sensors within the protective face mask that sense the emission of voice signals of the wearer.

In one embodiment, an internal battery (e.g., a disposable or a rechargeable battery) powers the various components of the face mask communication system of the present invention, and the voice signals captured by the microphone can be stored in a memory for future reference or transmitted to a connected electronic device, such as a smartphone, Bluetooth speaker or the like. The presence of noise cancellation features can also be embedded in the microphone and/or speaker, and the microphone may also be in the form of a beamforming microphone array.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a face mask communication system of the present invention in accordance with the disclosed architecture;

FIG. 2 illustrates a perspective view of one potential embodiment of a face mask communication system of the present invention in accordance with the disclosed architecture, wherein the system is being worn by a user;

FIG. 3 illustrates a block diagram of the major components of one potential embodiment of a face mask communication system of the present invention in accordance with the disclosed architecture;

FIG. 4 illustrates a perspective view of one potential method of amplification performed by the face mask communication system of the present invention in accordance with the disclosed architecture; and

FIG. 5 illustrates a perspective view of one potential embodiment of a face mask communication system of the present invention in accordance with the disclosed architecture, wherein the system is in wireless communication with a remote electronic device.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a protective face mask that protects an individual (and those in close proximity thereto) from the transmission of harmful pathogens and the spread of infectious diseases, and that enables the wearer to effectively communicate with others while wearing the face mask. There is also a long felt need in the art for a protective face mask that allows the wearer to remain masked while instructing or communicating with others so that the audience hears the information being conveyed by the wearer, and that eliminates the need for the wearer to shout or otherwise speak loudly to be heard. Further, there is a long felt need in the art for a protective face mask that enables the wearer to project his or her voice without straining, and while maintaining appropriate social distancing. Finally, there is a long felt need in the art for a protective face mask that is relatively inexpensive to manufacture and that is both safe and easy to use.

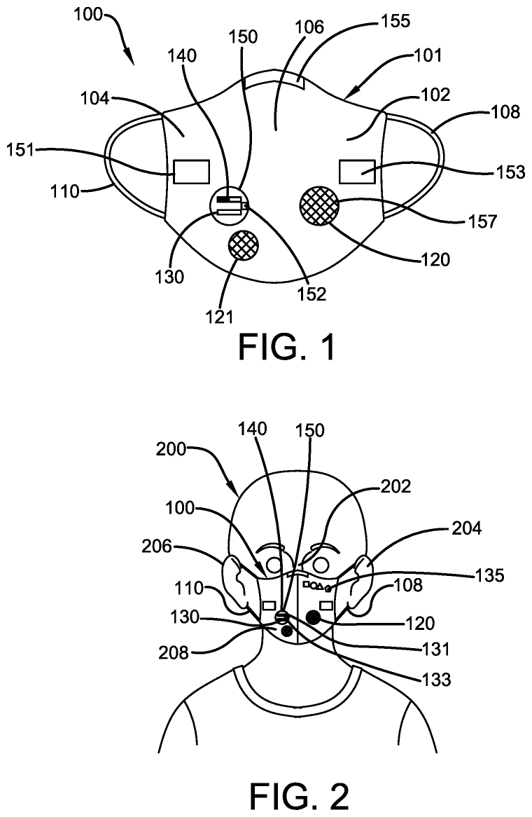

Referring initially to the drawings, FIG. 1 illustrates a perspective view of one potential embodiment of a face mask communication system 100 of the present invention in accordance with the disclosed architecture. As shown, the face mask portion or the face mask communication system 100 has a general shape and size similar to a conventional face mask to provide proper protection against pathogens, viruses (e.g., Covid-19, SARS, etc.), germs, harmful particulate matter and other undesirable microbes. More specifically, the microphone face mask system 100 has a right ear loop 110 and a left ear loop 108 to engage with the respective ears of the individual wearing the face mask system 100, as well as a left portion 102 and a right portion 104 that are separated by a rounded silhouette area 106. The left portion 102 and right portion 104 are similar in shape and size, and are configured to cover the left and right face portions of the individual wearing the microphone face mask system 100.

The right portion 104 further comprises a built-in speaker 150 to emit and amplify the sounds made by the user wearing the microphone face mask system 100. The built-in speaker 150 also has a mini-USB charging port or a USB charging port 130 and a toggle switch button 140 to turn on/off the built-in speaker 150. In a preferred embodiment, the built-in speaker 150 is positioned near the bottom of the right portion 104 such that the amplified sound emanating from the speaker 150 broadcasts outwardly easily to the person or people with whom the individual wearing the microphone facemask 100 is communication.

In one embodiment, the left portion 102 of the face mask system 100 is comprised of a microphone 120 which is substantially at a same position as of the speaker 150 present on the right portion 104 of the face mask system 100. The microphone 120 picks up the audible sounds emitted by the individual wearing the face mask system 100, and the speaker 150 projects the sound collected by the microphone 120 to project and broadcast the amplified sound to persons or people in the vicinity of the individual wearing the face mask system 100. More specifically, the power level of the sound is amplified by the speaker 150 which further comprises a built-in amplifier 152 and may be adjusted as needed by the user of the face mask system 100. Notwithstanding the forgoing, it is also contemplated that the speaker 150 could be positioned on the same panel as the microphone 120 so as to minimize the distance that the signal has to travel from the microphone 120 to the speaker 150, which are in electrical communication with one another. In one embodiment, the electrical communication between the microphone 120 to the speaker 150 is hardwired, though in another embodiment the connection may also be wireless (e.g., Bluetooth, WiFi, etc.).

The face mask portion 101 of the face mask system 100 may be comprised on a twill fabric, cloth, spun fibers or polypropylene fiber to maintain appropriate protection against harmful airborne pathogens, particulates, germs, diseases and the like. The face mask 101 fits comfortably on a user, is both stretchable and breathable, and can feature multiple filtration layers such as an inner skin-friendly absorbent layer, and a plurality of filter layers with the external layer featuring the microphone 120 and the speaker 150. The face mask 101 may also have one or more moisture wicking filters 151, 153 to allow wicking away of moisture from the user so as not to damage the microphone 120 or speaker150, and may also be infused with a pleasant scent (not shown). The ear loops 108, 110 are preferably elastic and adjustable, and the face mask 101 may also have a nose bridge 155 which is deformable to achieve a better fit against the user's face. The nose bridge 155 may be comprised of a non-metallic material such as a shape memory foam so as not to interfere with the operation of the microphone 120 and/or the speaker 150.

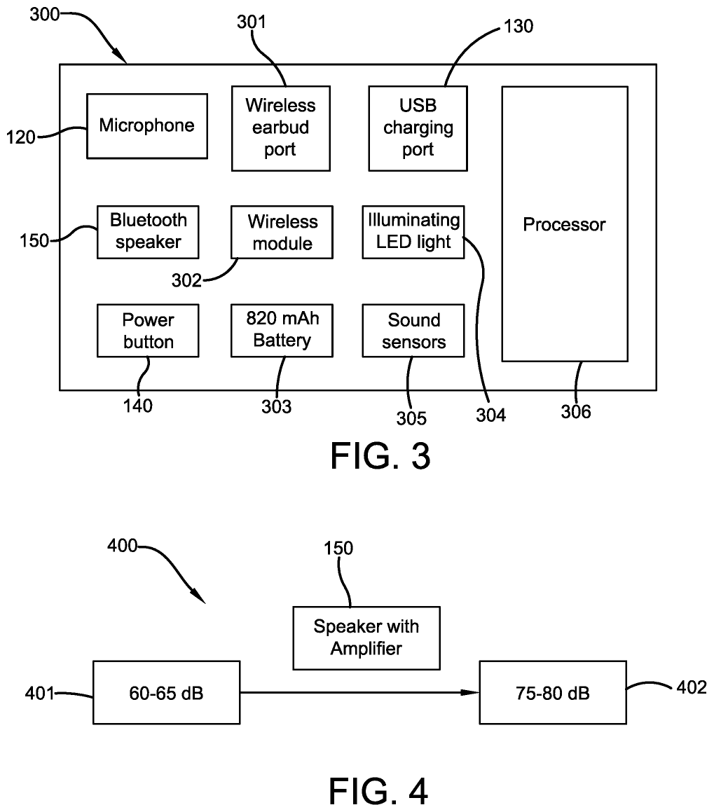

Additionally, the speaker 150 and the microphone 120 may be further connected to a processor/controller 306 (see e.g., FIG. 3) to control the operations of the components. The speaker 150 may also have a removable cover 157 so as to protect the speaker 150 from damage when the same is not in use, as well as to protect the integrity of the face mask 101 and not allow pathogens or other harmful particulates to enter into the face mask 101. The removable cover 157 and/or the face mask 101 itself may also be treated with or manufactured with an anti-microbial element such as, but not limited to, MicroBan® to further protect the individual when touching the cover 157 or the face mask 101. Both the speaker 150 and the microphone 120 may be manually operated using the switch button 140, or can be automatically operated via built-in sound sensors (not shown) which automatically power up the speaker 150 and the microphone 120 upon detection of audible sounds or other pre-established commands such as “turn on,” “good morning” or the like emanating from the wearer.

FIG. 2 illustrates a perspective view of one potential embodiment of a face mask communication system 100 of the present invention in accordance with the disclosed architecture, wherein the system 101 is being worn by a user 200. More specifically, the user 200 wears the face mask system 100 of the present invention in a manner similar to that of a conventional face mask, wherein the mask portion 1010 covers the nasal and oral passageways of the wearer 200 and the right ear loop 110 engages with the wearer's right ear 206 and the left ear loop 108 engages with the wearer's left ear 204.

Additionally, the upper seam of the face mask 101 covers the nose 202 and cheek bones of the user 200, and the bottom seam of the face mask 101 covers the mouth 208 of the user 200. The placement of the speaker 150 and the microphone 120 on the face mask 101 is such that they appear on the front of the mask 101 and near the lips of the user 200 when the mask is worn such that the microphone 120 picks up the audible sounds made by the user 200 clearly and passes the same onto the speaker 150 to amplify the sound and project the message to the wearer's audience in a clear and concise manner.

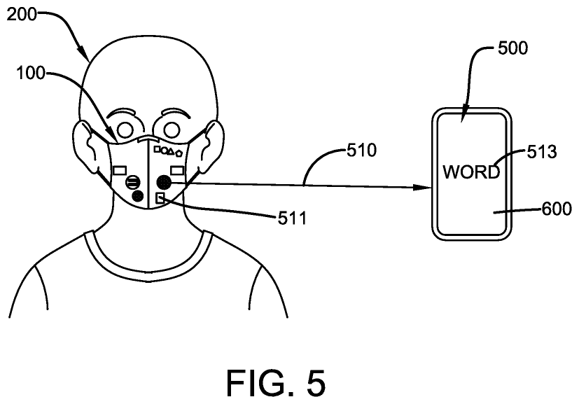

Furthermore, the microphone 120 may also comprise a directional antenna 131 to pick up the sound uttered by the user 100 and reject other generally inaudible sounds such as, but not limited to, breathing, sighing and the like. Similarly, the speaker 150 may further comprise a noise cancellation feature that helps in projecting an amplified and clear voice around the user 200 and that filters out any background noises that may occur in the vicinity of the user 200. During use, an optional LED light 511 (see e.g., FIG. 5) may also be illuminated indicating that both the speaker 150 and the microphone 120 are operational and/or also to indicate the remaining battery 303 life so that the user 200 knows when charging is required, or to replace the battery 303 if a disposable battery is used.

The user 200 may use the toggle button 140 to manually turn on or off the speaker 150 and the microphone 120 to conserve battery 303 life. For recharging the internal battery 303, a USB/mini-USB charging cord which is plugged into the charging port 133 can be used. In one embodiment, instead of a toggle button 140, a push button can be used and optionally, a volume control button to increase or decrease volume of the speaker 150 is present in order to control the volume of the speaker. It should be noted that the presence of the lightweight and aesthetically pleasing microphone 120 and speaker 150 facilitate audible communication between the wearer 200 and other individuals nearby. The wearer 200 can give instructions easily to the public while wearing the face mask communication system 100 via the microphone 120 and the speaker 150, thereby facilitating effective communication while also maintaining the safety of the wearer 200 and others in close proximity thereto. It should also be appreciated that the shape and configuration of the right portion 104 and the left portion 102, along with the shape and configuration of the ear loops 108, 110 can be customized based on different designs 135 while maintaining the efficiency of the microphone 120, the speaker 150 and providing protection to the wearer 200 and others in close proximity thereto.

FIG. 3 illustrates a block diagram 300 of the major components of one potential embodiment of a face mask communication system 100 of the present invention in accordance with the disclosed architecture. More specifically, the component block diagram 300 shows that an internal battery 303 of a power such as 820mAh is preferably integrated within the face mask 101 to power the microphone 120, and a Bluetooth speaker 150. Both the speaker 150 and the microphone 120 are connected to a wireless module such as Bluetooth/Wi-Fi SoC 302, and a power button 140 is present to manually turn on/off the speaker 150 and/or the microphone 120. Also, as referenced above, the face mask communication system 100 also preferably comprises a mini-USB/USB charging port 130 to charge the battery 303 and/or the various components of the face mask system 100.

In one embodiment, the integrated face mask system 100 may comprise optional LED lights 511 positioned along the exterior surface (i.e., the surface facing outwardly from the wearer 200, as compared to the interior surface) of the face mask 101 to indicate the remaining battery level of the internal battery 303 and also to indicate whether the various components are turned on or off and whether the wearer 200 is speaking. The processor/controller 306 acts as the controlling component to send controlling instructions to the various components of the integrated face mask communication system 100.

Additionally, in a further embodiment, one or more sound sensors 305 may be built into the face mask 100 to automatically turn on the speaker 150 and the microphone 120 when a wearer 200 of the face mask system 100 begins to speak. Further, an optional earbud port 301 may also be provided to connect an earphone (not shown) that may also be present on the face mask system 100. In this manner, it should also be appreciated that using the wireless module 302, the face mask communication system 100 can connect to any electronic device or consumer device through a wireless channel.

FIG. 4 illustrates a perspective view of one potential method of amplification 400 performed by the face mask communication system 100 of the present invention in accordance with the disclosed architecture. As stated earlier, the speaker 150 has an amplifier 152 to amplify the sound signals emitted by the wearer 200 to increase the broadcast of the sound signals and enable the same to be transmitted over a greater distance and with more clarity. This also allows the wearer 200 to speak without having to shout or speak loudly, which could be tiresome over a prolonged period of time. As an example, the microphone 120 may detect a sound uttered 401 by the wearer 200 in the range 60-65 dB, which may not be loud enough to hear by one or more persons (listeners) if a conventional mask were being work by the speaker. Accordingly, the sound signals from the microphones 120 of the current face mask communication system 100 are passed to the speaker 150 having a built-in amplifier 152 to amplify the sound signal and increase the power level enough so that the audience can clearly hear the voice of the individual that is speaking. By way of example and not limitation, the amplifier 152 may amplify the signal power to an amplified signal having a power in the range 75-85 dB. The increased power level enables the voice signals to be amplified and projected easily for an effective communication, and also eliminates the need for the wearer 200 to remove the face mask 101 to effectively communicate with others. Notwithstanding, it should be appreciated that the above referenced amplification can be more or less as per the preferences of the wearer 200, and will also depend on the type of microphone 120 and speaker 121, 150 used in the face mask communication system 100.

FIG. 5 illustrates a perspective view of one potential embodiment of a face mask communication system 100 of the present invention in accordance with the disclosed architecture, wherein the system 100 is in wireless communication with a remote electronic device 500. More specifically and as stated earlier, the face mask system 100 has a wireless module 302 to enable a wireless connection between the face mask system 100 and an electronic or consumer device 500 such as a smartphone, Bluetooth speaker or the like. The microphone 120 is connected to the electronic device 500 after pairing through a wireless communication technology such as, but not limited to, Bluetooth/Wi-Fi Direct/Infrared etc. and the sound signals captured by the microphone 120 are transferred to the smartphone 500 through the communication channel 510. The microphone 120 can also be connected to the smart device 500 to talk on a call in a manner similar to a wireless microphone and speaker. The smart device 500 may also have a closed caption feature 513 which shows the words being spoken on the screen so that those who may be deaf or hard of hearing can readily understand the words being spoken.

The face mask 101 may be manufactured using a plastic, cloth, non-woven, woven material, synthetic fibers, natural fibers, PTE material, spun bonded materials, or combinations thereof. Also, the ear loops 108, 110 may be manufactured using an elastic material, hook and loop strap, or other materials as per the needs and requirements of the user 200. Furthermore, the various components such as the speakers 121, 150, charging port 133, power button 140, and other components may be disposed along any portion of face mask 101. Stated differently, the placement of the various components is not fixed, and the same can be placed on either side of the mask body 110. Additionally, in one embodiment, the system 100 may further comprise a software application 600 that is used to operate the various components of the face mask system 100. The software application 600 may be installable on any electronic device 500 such as a smartphone, laptop, tablet, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “microphone mask”, “improved face mask”, “microphone integrated face mask”, “face mask system”, etc. are interchangeable and refer to the face mask communication system 100 of the present invention.

Notwithstanding the forgoing, the face mask communication system 100 of the present invention and its various components can be of any suitable size and configuration as is known in the art without affecting the overall concept of the invention, provided that the same accomplish the above stated objectives. One of ordinary skill in the art will appreciate that the size, configuration and material of the face mask communication system 100 and its various components as shown in the FIGS. are for illustrative purposes only, and that many other sizes and shapes of the face mask communication system 100 are well within the scope of the present disclosure. Although the dimensions of the face mask communication system 100 and its various components are important design parameters for user convenience, the face mask communication system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A face mask communication system comprising:
a face mask sized and configured to cover a nose and mouth region of a wearer and having an interior surface and an exterior surface;
a microphone disposed on the interior surface of the face mask near the mouth region of the wearer; and
a speaker disposed on an exterior surface of the face mask.

2. The face mask communication system as recited in claim 1, wherein each of the speaker and the microphone are positioned on a left panel or a right panel of the face mask.

3. The face mask communication system as recited in claim 2, wherein the speaker is positioned on a different panel than the microphone.

4. The face mask communication system as recited in claim 1, wherein the speaker is provided with a removable cover and is in wireless communication with the speaker.

5. The face mask communication system as recited in claim 4, wherein the removable cover comprises an anti-microbial element.

6. The face mask communication system as recited in claim 1, wherein the microphone comprises a high pass filter to remove lower frequency sounds.

7. The face mask communication system as recited in claim 1, wherein the microphone and the speaker are connected to a processor.

8. The face mask communication system as recited in claim 7, wherein the processor is connected to a remote device for emitting sounds or providing a display on the remote device.

9. The face mask communication system as recited in claim 8, wherein the remote device is one of a smartphone or a speaker.

10. The face mask communication system as recited in claim 8, wherein the remote device has a closed caption feature for displaying words spoken by a wearer of the face mask.

11. The face mask communication system as recited in claim 1 further comprising an amplifier, wherein the face mask comprises at least one moisture wicking feature disposed on the exterior surface of the face mask.

12. The face mask communication system as recited in claim 7, wherein the processor is connected to a LED light positioned along the exterior surface of the face mask.

13. A face mask communication system comprising:
a face mask having an interior surface and an exterior surface, wherein the face mask is sized and configured to fit over a nose and a mouth region of a wearer;
an internal speaker disposed on the exterior surface of the face mask;
a microphone disposed on the interior surface of the face mask and positioned near the mouth region of the wearer;
an amplifier; and
a processor for controlling a volume of the speaker and the microphone.

14. The face mask communication system as recited in claim 13 further comprising an external speaker or a display connected to the processor.

15. The face mask communication system as recited in claim 14, wherein the external speaker or the display is a portion of a smartphone.

16. The face mask communication system as recited in claim 15, wherein the smartphone has a closed caption display in communication with the processor.

17. The face mask communication system as recited in claim 13, wherein the microphone comprises a high pass filter and the internal speaker emits an amplified sound in a range between 75 and 85 dB.

18. The face mask communication system as recited in claim 13, wherein the face mask is made from one of a plastic, a cloth, a non-woven, a woven material, a PTE material, a synthetic fiber, a natural fiber, a spun bonded material or a combination thereof.

19. A protective face mask comprising;
a face mask body having an interior surface, an exterior surface, a left panel, a right panel, a deformable nose bridge, a left ear loop and a right ear loop;
a microphone comprised of a directional antenna and a high pass filter;
an amplifier;
a speaker;
a LED light; and
a processor, wherein each of the speaker, the amplifier and the microphone are in communication with the processor.

20. The protective face mask as recited in claim 19, wherein the speaker is one of an internal speaker or a remote speaker.
